(19) United States
(12) Patent Application Publication
(10) Pub. No.: US 2022/0164730 A1
(43) Pub. Date: May 26, 2022

(54) MULTI-FACTOR REAL TIME DECISION MAKING FOR OIL AND GAS OPERATIONS

(71) Applicant: Well Thought LLC, Denver, CO (US)

(72) Inventor: William Edwin Melton, Denver, CO (US)

(73) Assignee: Well Thought LLC, Denver, CO (US)

(21) Appl. No.: 17/535,213

(22) Filed: Nov. 24, 2021

Related U.S. Application Data
(60) Provisional application No. 63/118,490, filed on Nov. 25, 2020.

(51) Int. Cl. G06Q 10/06; G06Q 50/06; G06N 20/00

(52) U.S. Cl. CPC G06Q 10/0635; G06N 20/00; G06Q 50/06

(57) ABSTRACT

A method may include monitoring a state of a service operation including settings and results to obtain a monitored state including at least trends in the results, detecting, using the monitored state, an intervention point of a user, identifying a change to the service operation corresponding to the intervention point, and recommending the change to the service operation based on applying a utility model of the user to the monitored state.

### CROSS-REFERENCE TO RELATED APPLICATION

This application claims benefit under 35 U.S.C. § 119(e) to U.S. Provisional Patent Application Ser. No. 63/118,490, filed on Nov. 25, 2020, having the same inventors, and entitled, “MULTI-FACTOR REAL TIME DECISION MAKING FOR OIL AND GAS OPERATIONS.” U.S. Provisional Patent Application Ser. No. 63/118,490 (Attorney Docket Number 10861/002001) is incorporated herein by reference in its entirety.

### BACKGROUND

The current paradigm for decision-making in oil and gas operations is characterized by individual on-site representatives making decisions with a lack of clearly defined goals and understanding of client preferences for changes. Much of current paradigm decision making is “seat of the pants” at the moment of action.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including monitoring a state of a service operation including settings and results to obtain a monitored state including at least trends in the results, detecting, using the monitored state, an intervention point of a user, identifying a change to the service operation corresponding to the intervention point, and recommending the change to the service operation based on applying a utility model of the user to the monitored state.

In general, in one aspect, one or more embodiments relate to a system including a computer processor, a repository configured to store a service operation including a state including settings and results, intervention points each corresponding to a change to the service operation, and a utility model of a user. The system further includes a recommendation engine, executing on the computer processor and configured to monitor the state of the service operation to obtain a monitored state including at least trends in the results, detect, for the user and using the monitored state, an intervention point, identify a change to the service operation corresponding to the intervention point, and recommend the change to the service operation based on applying the utility model of the user to the monitored state.

In general, in one aspect, one or more embodiments relate to a non-transitory computer readable medium including instructions that, when executed by a computer processor, perform monitoring a state of a service operation including settings and results to obtain a monitored state including at least trends in the results, detecting, using the monitored state, an intervention point of a user, identifying a change to the service operation corresponding to the intervention point, and recommending the change to the service operation based on applying a utility model of the user to the monitored state.

Other aspects of the invention will be apparent from the following description and the appended claims.

### BRIEF DESCRIPTION OF DRAWINGS

FIG. 1 shows a system in accordance with one or more embodiments of the invention.

FIG. 2A and FIG. 2B show flowcharts in accordance with one or more embodiments of the invention.

FIGS. 3A-3J show examples in accordance with one or more embodiments of the invention.

FIG. 4A and FIG. 4B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to optimizing a service operation. The service operation may be a service contracted by the user. For example, the service operation may be used in the construction, completion, and/or production of an oil or gas well. A state of the service operation may be monitored to obtain a monitored state that includes operational results and/or financial results (e.g., costs) of the service operation. An intervention point of a user may be detected when a trigger condition of the intervention point has been satisfied by the results of the service operation in the monitored state. The trigger condition may specify a point in time and/or results generated during the execution of the service operation. The intervention point may have been learned from historical data including previously completed service operations of a user. For example, the historical data may include intervention points and corresponding service operation changes selected by the user. A change to the service operation corresponding to the intervention point may be identified. For example, the change to the service operation may cause a cost trend of the service operation to satisfy a preferred financial outcome of the user as defined in a utility model of the user. The change to the service operation may be recommended based on applying the utility model of the user to the monitored state. For example, the change to the service operation may be recommended when the change to the service operation satisfies, in the monitored state, risk tolerance preferences of the user. The risk tolerance preferences may indicate how closely the state of the service operation needs to match an intervention point before a service change is performed. The utility model may assign weights that represent the relative importance of various service outcomes and/or financial outcomes of the service operation. Service outcomes may be outcomes tied to specific technical and/or operational results. Financial outcomes may be outcomes tied to specific financial results (e.g., costs). Thus, the utility model may be used to represent tradeoffs between service outcomes and/or financial outcomes.

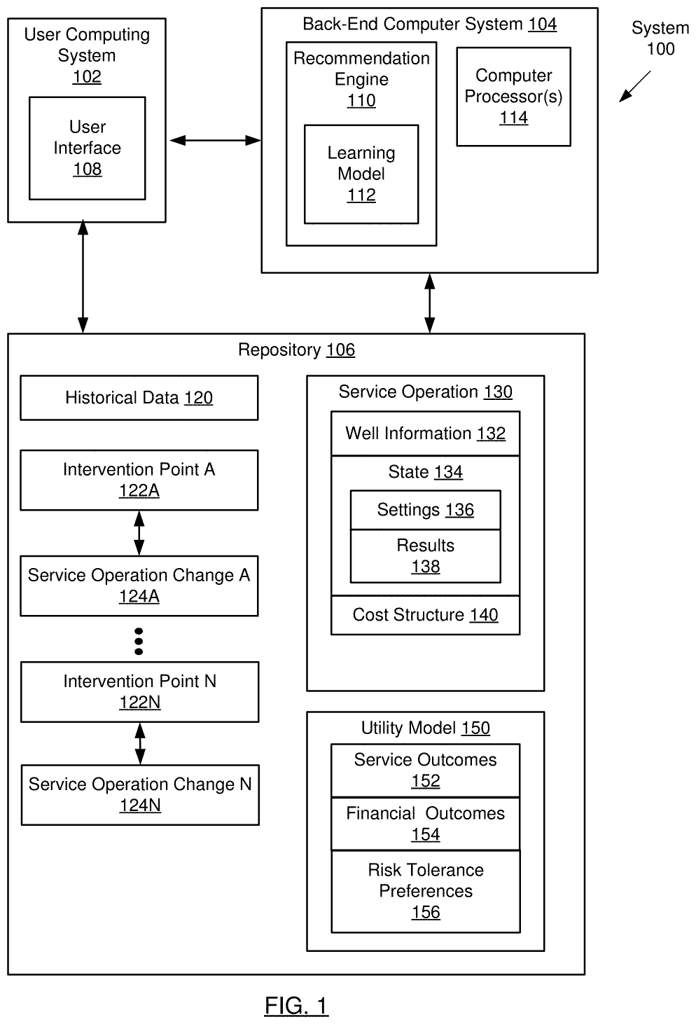

FIG. 1 shows a diagram of a system (100) in accordance with one or more embodiments. As shown in FIG. 1, the system (100) includes multiple components such as the user computing system (102), a back-end computer system (104), and a repository (106). Each of these components is described below.

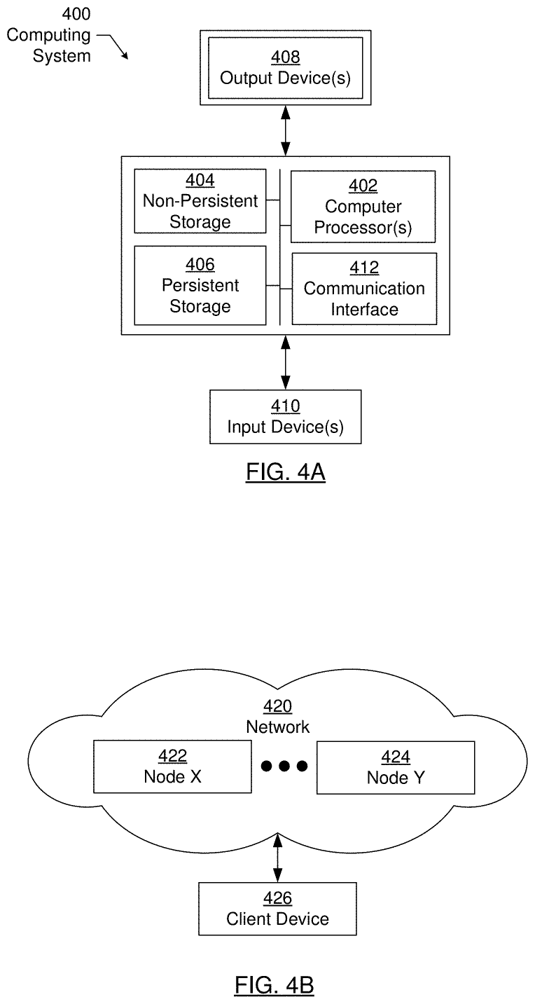

In one or more embodiments, the user computing system (102) provides, to a user, a variety of computing functionality. For example, the user may be a customer of a service operation (140). The user computing system (102) may be a mobile device (e.g., phone, tablet, digital assistant, laptop, etc.) or any other computing device (e.g., desktop, terminal, workstation, etc.) with a computer processor (not shown) and memory (not shown) capable of running computer software. The user computer system (102) may take the form of the computing system (400) shown in FIG. 4A connected to a network (420) as shown in FIG. 4B.

The user computing system (102) may include a user interface (UI) (108) for receiving input from a user and transmitting output to the user. For example, the UI (108) may be a graphical user interface or other user interface to a computer program executing on the user computing system (102). The computer program may be a software application written in any programming language that includes executable instructions stored in some sort of memory. The instructions, when executed by one or more processors, enable a device to perform the functions described in accordance with one or more embodiments. The UI (108) may be rendered and displayed within a local desktop software application or the UI (108) may be generated by a remote web server and transmitted to a user's web browser executing locally on a desktop or mobile device. In one or more embodiments, the UI (108) includes functionality to permit a user to define and/or edit a service operation (140).

Continuing with FIG. 1, the back-end computer system (104) may include a recommendation engine (110) and computer processor(s) (114). The back-end computer system (104) may be executed on a computing system (400) shown in FIG. 4A connected to a network (420) as shown in FIG. 4B. The repository (106) is any type of storage unit and/or device (e.g., a file system, database, collection of tables, or any other storage mechanism) for storing data. Further, the repository (106) may include multiple different storage units and/or devices. The multiple different storage units and/or devices may or may not be of the same type or located at the same physical site. The repository (106) may be accessed online via a cloud service (e.g., Amazon Web Services, Egnyte, Azure, etc.).

The repository (106) includes functionality to store historical data (120), intervention points (122A, 122N), service operation changes (124A, 124N), a service operation (140), and/or a utility model (150). The service operation (140) may be a service contracted by the user. For example, the service operation (140) may be an operation used in the construction, completion, and/or production of an oil or gas well. Continuing this example, a service operation (140) may include pumping, stimulation/fracturing treatments, directional drilling, drilling fluid, coil tubing or workover services, etc. The service operation (140) may include well information (142), a state (134), and a cost structure (140). Well information (142) may include a Unique Well Identifier (UWI), well name, and/or well number. For example, the UWI may be randomly generated or may be an identifier associated with the well (e.g., an American Petroleum Institute (API) number).

The state (134) may include settings (136) and results (138). The settings (136) may include parameters that affect and/or control the behavior of the service operation (140). Examples of settings may include: treating rate, stage volume, friction reducer concentration, etc. Each of the settings (136) may have a value. The setting (136) may specify a maximum and/or minimum allowable value. For example, the value may be a numerical value (e.g., a temperature represented in terms of degrees), or a categorical value (e.g., a temperature represented as “hot”, “warm”, or “cold”). The results (138) may include outputs that result from executing the service operation (140). For example, the results (138) may include measurements of sensors and/or other devices used in the service operation (140). Examples of results may include: surface pressure, pad pressure, friction reducer concentration, etc. In one or more embodiments, the results (138) include costs incurred during the execution of the service operation (140).

The cost structure (140) may define the costs of executing the service operation (140). In one or more embodiments, the cost structure (140) includes costs of inputs to the service operation (140). For example, the cost structure (140) may include tables (e.g., defined by a subject matter expert) into which the user may enter unit costs of inputs to the service operation (140). Alternatively or additionally, the cost structure (140) may include formulas by which the costs of inputs to the service operation (140) may be calculated. In one or more embodiments, the cost structure (140) includes operating costs of the service operation (140). For example, the cost structure (140) may include operating costs of various steps performed during the execution of the service operation (140). As another example, the cost structure (140) may include operating costs of equipment used during the execution of the service operation (140).

An intervention point (122A) may include a trigger condition. The trigger condition may specify a point in time and/or results (138) generated during the execution of a service operation (140). Examples of trigger conditions may include: an increase in treating pressure above a threshold pressure, a loss of circulation below a threshold level of circulation, downhole motor stall, etc. Each intervention point (122A) may correspond to a service operation change (124A). The service operation change (124A) may represent a preferred action of a user to be applied at the intervention point (122A). The service operation change (124A) may be a change to one or more settings (136) of the service operation (140). Examples of service operation changes may include: tripping to change a bit or motor, changing mud density, pumping a sweep on a frac job, etc. Other examples of service operation changes may include: stopping, pausing, resuming, or resetting the service operation (140).

The point in time of the intervention point (122A) may be represented as a time interval expressed relative to a starting point of the service operation (140). For example, different service operation changes may be preferred by a user at different times given the same results (138) generated during the execution of a service operation (140). For example, the user may prefer that one service operation change be performed at the beginning of the service operation (140) and a different service operation change be performed at the end of the service operation (140) even though the same results (138) may be generated at both the beginning of the service operation (140) and at the end of the service operation (140).

The utility model (150) includes service outcomes (152), financial outcomes (154), and risk tolerance preferences (156). An outcome is a generic term representing a quantified goal of the service operation (140). The goal may be expressed in terms of one or more results (138) of the service operation (140). For example, an outcome may be quantified with a value or a range of values. Continuing this example, the range of values may include minimum and/or maximum levels (e.g., maximum cost, maximum drilling depth, etc.). Service outcomes (152) may be outcomes tied to specific technical and/or operational results (138). Examples of service outcomes may include: placing 90% of volume, drilling 95% of target depth, etc. Financial outcomes (154) may be outcomes tied to specific financial results (138). Examples of financial outcomes may include: actual or projected costs exceed 5% of expected costs, etc. The utility model (150) may assign weights to the service outcomes (152) and/or financial outcomes (154) to represent the relative importance, to a user, of the service outcomes (152) and/or financial outcomes (154) in order to maximize user-defined utility. Thus, the utility model (150) may be used to represent tradeoffs between service outcomes (152) and/or financial outcomes (154).

In one or more embodiments, the utility model (150) includes technical outcomes, which are derived values such as a net pressure or stimulated reservoir volume. In one or more embodiments, the utility model (150) includes negative outcomes, which may be events that are viewed as undesirable results, for example, due to being too risky or resulting from inadequate control of the service operation (140). Examples of negative outcomes may include a screen-out on a frac job or a gas kick during drilling.

The risk tolerance preferences (156) may indicate how closely the state (134) of the service operation (140) needs to match an intervention point (122A). For example, a user with high risk tolerance preferences (156) may be willing to wait until an intervention point (122A) is actually reached before taking action to perform the corresponding service operation change (124A). Alternatively, a user with low risk tolerance preferences (156) may prefer to take preemptive action when trends in the state (134) of the service operation (140) suggest that an intervention point (122A) is likely to be reached. Alternatively, the risk tolerance preferences (156) may indicate a threshold confidence level to be achieved before performing the service operation change (124A) corresponding to the intervention point (122A) (e.g., where the threshold confidence level is derived from trends in the state (134) of the service operation (140)). The risk tolerance preferences (156) may be viewed as a “throttle” or “gate” that represents the user's unique decision-making preferences. As an example, a risk tolerance preference (156) may indicate that a user is willing to incur an additional 1% of the total cost of the service operation (140) (e.g., a financial outcome) to gain an additional foot of drilling depth (e.g., a service outcome).

The recommendation engine (110) includes a learning model (112). The learning model (112) may include a set of heuristics (e.g., rules). Alternatively, the learning model (112) may be a machine learning model. For example, the learning model (112) may be implemented as various types of deep learning classifiers and/or regressors based on neural networks (e.g., based on convolutional neural networks (CNNs)), random forests, stochastic gradient descent (SGD), a lasso classifier, gradient boosting (e.g., XGBoost), bagging, adaptive boosting (AdaBoost), ridges, elastic nets, or Nu Support Vector Regression (NuSVR). Deep learning, also known as deep structured learning or hierarchical learning, is part of a broader family of machine learning methods based on learning data representations, as opposed to task-specific algorithms.

The learning model (112) includes functionality to identify intervention points (122A, 122N) and corresponding service operation changes (124A, 124N) using historical data (120). The historical data (120) may include previously completed service operations (140) of a user. That is, the historical data (120) may be used to train the learning model (112). The historical data (120) may include data of the user collected via the UI (108). For example, the historical data (120) may include intervention points (122A, 122N) and corresponding service operation changes (124A, 124N) selected by the user via the UI (108). In other words, the service operation changes (124A, 124N) may be changes to the service operations (140) that the user would have requested had the user been on-site during the execution of the service operations (140).

The historical data (120) may further include results (138), service outcomes (152) and/or financial outcomes (154) corresponding to the intervention points (122A, 122N). In one or more embodiments, the learning model (112) includes functionality to adjust parameters of the utility model (150) using the historical data (120). For example, the learning model (112) may include functionality to adjust the risk tolerance preferences (156) of the utility model (150) using the results (138), service outcomes (152) and/or financial outcomes (154) in the historical data (120). Alternatively, risk tolerance preferences (156) may be defined by the user through a series of questions presented via the UI (108) and/or other interactions between the user and the UI (108).

The recommendation engine (110) includes functionality to monitor the state (134) of a service operation (140). The recommendation engine (110) includes functionality to detect an intervention point (122A) in a state (134) of the service operation (140). The recommendation engine (110) includes functionality to recommend a service operation change (124A) corresponding to the intervention point (122A) by applying the utility model (150) to the state (134) of the service operation (140).

In one or more embodiments, the computer processor(s) (114) takes the form of the computer processor(s) (402) described with respect to FIG. 4A and the accompanying description below. The computer processor (114) includes functionality to execute the recommendation engine (110).

While FIG. 1 shows a configuration of components, other configurations may be used without departing from the scope of the invention. For example, various components may be combined to create a single component. As another example, the functionality performed by a single component may be performed by two or more components.

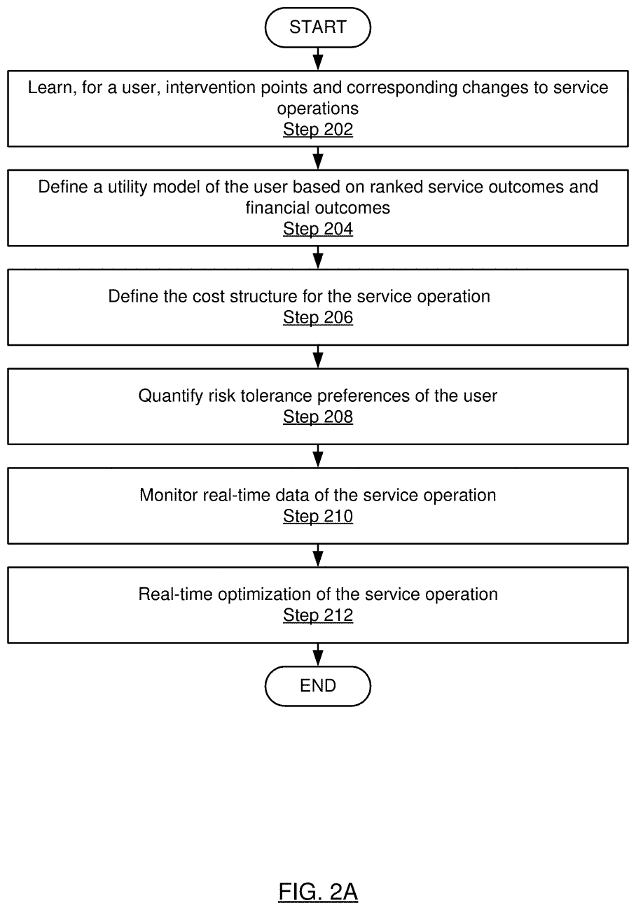

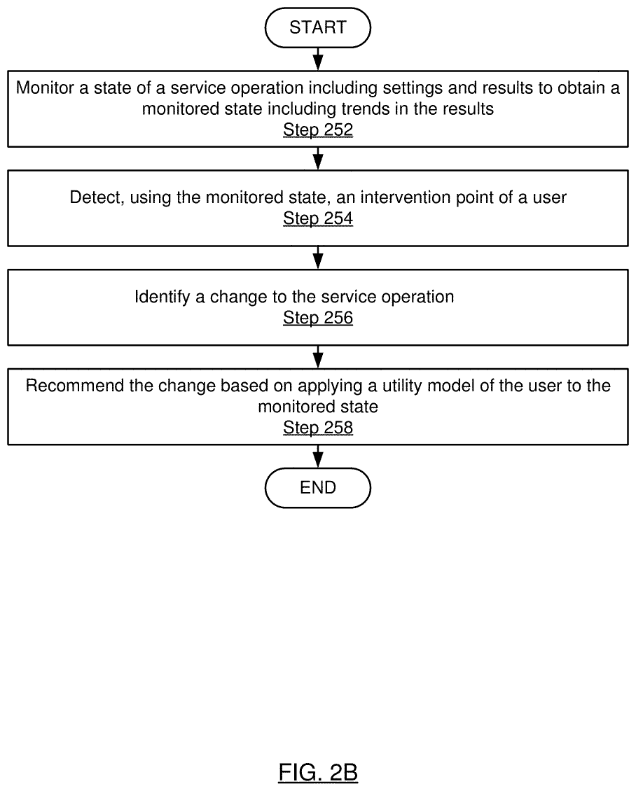

FIG. 2A shows a flowchart in accordance with one or more embodiments of the invention. The flowchart depicts a process for optimizing a service operation. One or more of the steps in FIG. 2A may be performed by the components (e.g., the recommendation engine (110) and the user interface (UI) (108) of the system (100)), discussed above in reference to FIG. 1. In one or more embodiments of the invention, one or more of the steps shown in FIG. 2A may be omitted, repeated, and/or performed in parallel, or in a different order than the order shown in FIG. 2A. Accordingly, the scope of the invention should not be considered limited to the specific arrangement of steps shown in FIG. 2A.

Initially, in Step 202, intervention points and corresponding changes to a service operation are learned for a user. The recommendation engine may learn the intervention points and corresponding changes to the service operation preferred by the user based on the user's selections of intervention points and corresponding changes to the service operation in historical data on previously completed service operations. For example, the user may select intervention points and corresponding changes to service operations in historical data via a user interface (UI). Continuing this example, the UI may present a menu of changes to service operations from which the user may select.

In Step 204, a utility model of the user is defined based on ranked service outcomes and financial outcomes. The ranked service outcomes and financial outcomes may be based on information obtained from the user via the UI. For example, the UI may prompt the user to formalize tradeoffs between various service outcomes and financial outcomes by expressing relationships between various service outcomes and financial outcomes. Continuing this example, the user may express that he/she is willing to incur a cost increase of 1% (a financial outcome) for each additional foot of drilling depth (a service outcome).

In Step 206, the cost structure for the service operation is defined. The user may define the cost structure for the service operation via the UI. For example, the UI may prompt the user to complete data tables that define unit costs for inputs to the service operation. In one or more embodiments, different cost structures may be defined corresponding to different vendors providing the same service operation.

In Step 208, risk tolerance preferences of the user are quantified. The UI may prompt the user to respond to a series of questions that may be the basis for quantifying the risk tolerance of the user (e.g., including risk tolerances for negative outcomes in service operations).

In Step 210, real-time data of the service operation is monitored. The recommendation engine may obtain and monitor data regarding the evolving state of the service operation. For example, the recommendation engine may monitor the state of the service operation in order to detect potential intervention points of the user, as described below in Step 254.

In Step 212, the service operation is optimized in real-time. The real time data from monitored in Step 210 above may be processed as described in FIG. 2B below.

FIG. 2B shows a flowchart in accordance with one or more embodiments of the invention. The flowchart depicts a process for optimizing a service operation. One or more of the steps in FIG. 2B may be performed by the components (e.g., the recommendation engine (110) and the user interface (UI) (108) of the system (100)), discussed above in reference to FIG. 1. In one or more embodiments of the invention, one or more of the steps shown in FIG. 2B may be omitted, repeated, and/or performed in parallel, or in a different order than the order shown in FIG. 2B. Accordingly, the scope of the invention should not be considered limited to the specific arrangement of steps shown in FIG. 2B.

Initially, in Step 252, a state of a service operation is monitored to obtain a monitored state. The monitored state includes at least trends in the results of the service operation. The recommendation engine may continuously (e.g., at periodic intervals) monitor operational results and/or financial results (e.g., costs) of the service operation. In other words, the monitored state includes operational results and/or financial results. Operational results of the service operation may be obtained using various sensors and/or measurement devices. Financial results of the service operation may be calculated using the cost structure defined in Step 206 above.

In Step 254, an intervention point of a user is detected using the monitored state. The recommendation engine may detect the intervention point by determining that the trigger condition of the intervention point has been satisfied by the results of the service operation in the monitored state. In one or more embodiments, the recommendation engine may detect the intervention point by determining that the trigger condition of the intervention point has been satisfied by a trend in the results of the service operation in the monitored state.

In Step 256, a change to the service operation corresponding to the intervention point is identified. The recommendation engine may obtain the change to the service operation corresponding to the intervention point from a repository. The recommendation engine may obtain the change to the service operation corresponding to the intervention point from a repository by querying the repository with an identifier of the intervention point. For example, the change to the service operation may cause a cost trend of the service operation to satisfy a preferred financial outcome of the user as defined in the utility model.

In Step 258, the change to the service operation is recommended based on applying the utility model of the user to the monitored state. The recommendation engine may recommend the change to the service operation based on determining that the change to the service operation satisfies, in the monitored state, the risk tolerance preferences of the user. For example, the recommendation engine may compare trends in the results of the monitored state to financial and/or service outcomes of the utility model, and then determine whether the risk tolerance preferences of the utility model are satisfied.

The UI may present a dialog box to the user with specific instructions corresponding to the recommended change to the service operation. The recommendation engine may update the historical data based on whether the user accepts or rejects the recommended change to the service operation corresponding to the intervention point. In this manner, the recommendation engine may update (e.g., retrain) the learning model as additional decisions of the user regarding intervention points and corresponding changes to the service operation are obtained during the execution of the process of FIG. 2B.

The commercial adoption of this solution may provide several financial and operational benefits. First, the application of rigorous decision making may reduce the variance in expenditures by limiting the frequency of cost overruns. Additionally, the use of a digital solution may give clients the option to utilize fewer on-site representatives or representatives with different skill sets, both of which result in lower operating cost. The transition from personnel-driven decisions to rigorous, consistent digital decision making may result in improved business continuity compared to historical rates of personnel turnover or unavailability due to travel or other factors. Finally, the client may see their specific decision-making process actively deployed in their operations.

The deployment of this solution represents a marked step change from the current paradigm of service execution in speed, rigor, and consistency. This solution is orders of magnitude faster than human decision making process because it is not distracted by other mental burdens (both work and non-work related), because it is constantly considering options for optimization and looking for opportunities. In contrast, this solution is constantly evaluating the cost and operational impacts of any action to make the optimizing decision based on client unique preferences. Finally, this solution is consistent in its calculations and execution regardless of the time of day, weather, and holidays; while the current paradigm sees dramatic differences in choices between different on-site representatives or even the same representative from day to day.

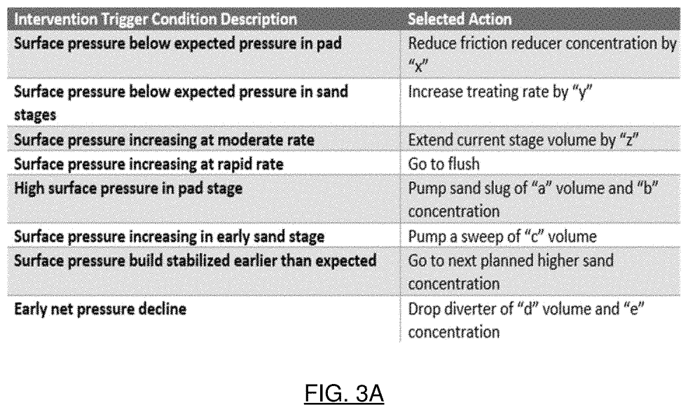

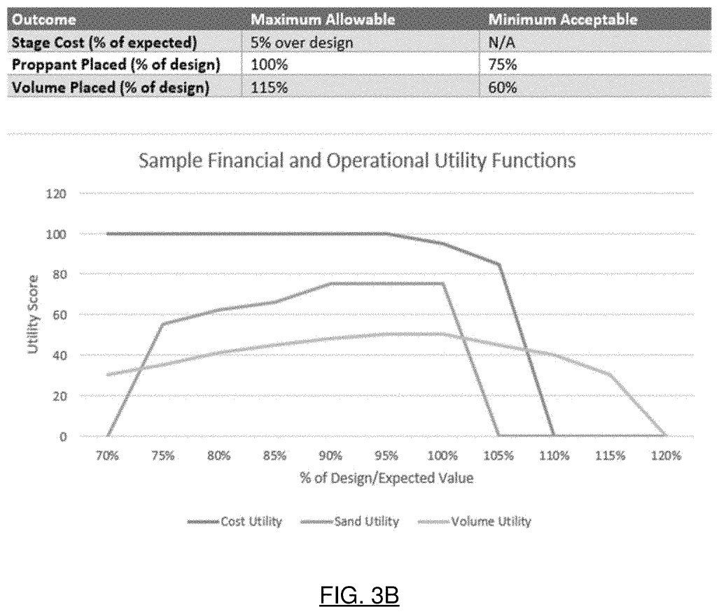

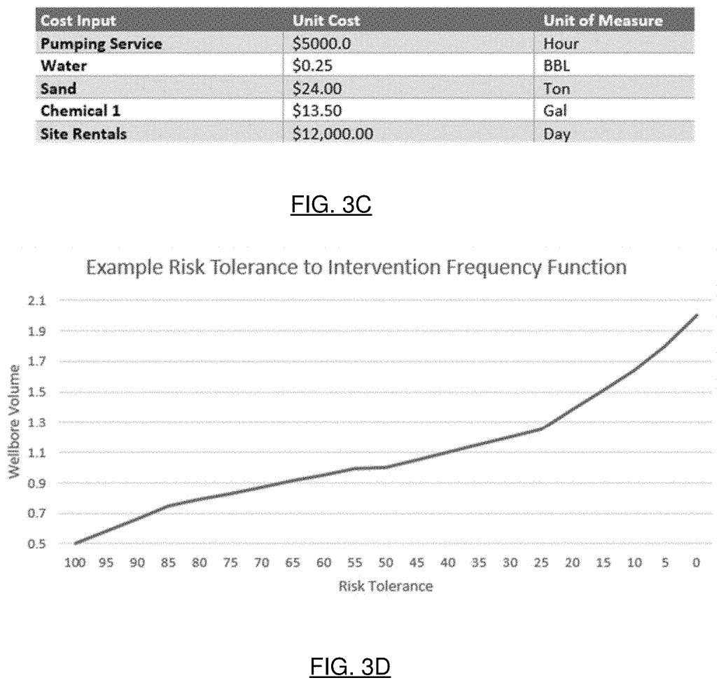

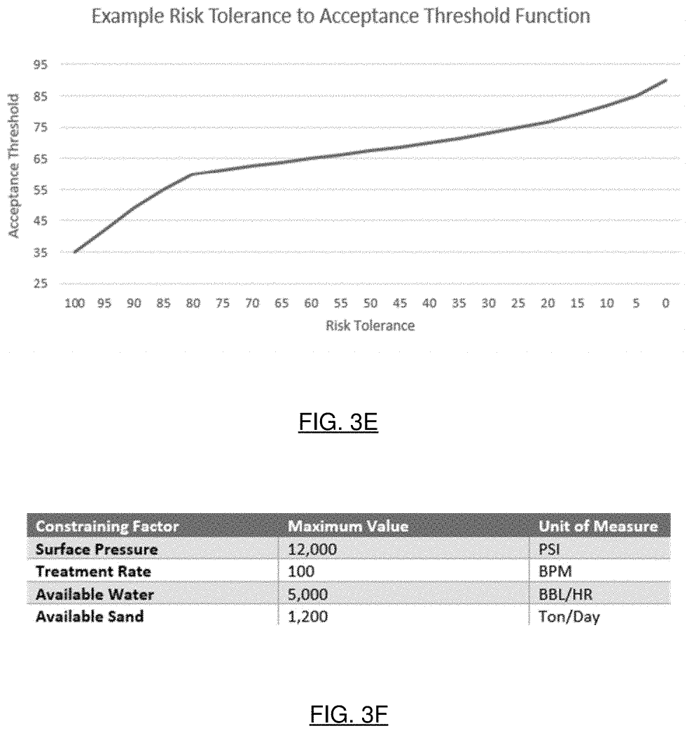

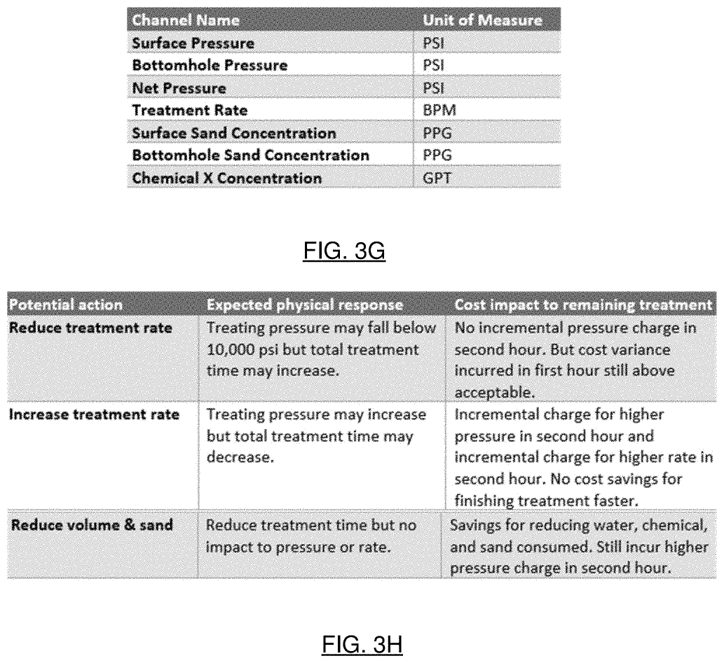

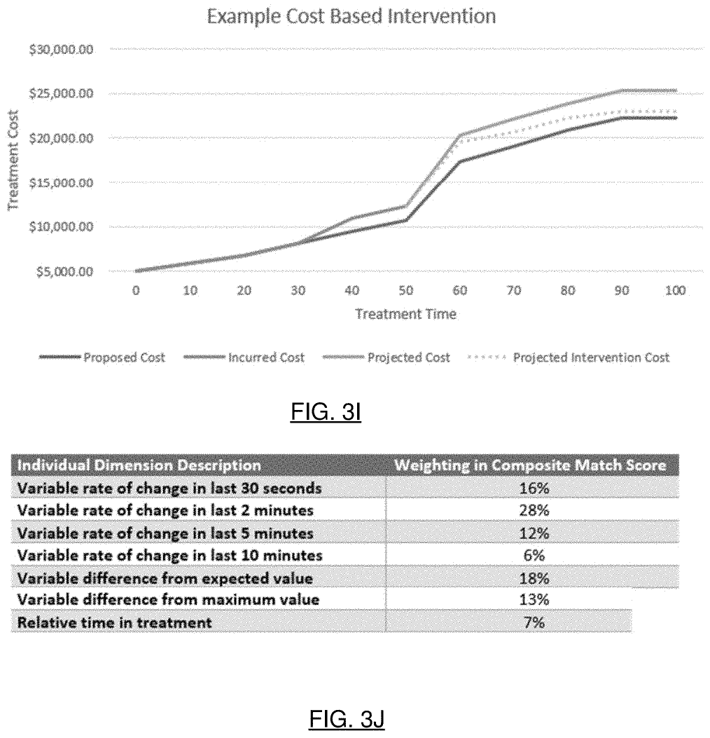

FIGS. 3A-3J show implementation examples in accordance with one or more embodiments. The implementation examples are for explanatory purposes only and not intended to limit the scope of the invention. One skilled in the art will appreciate that implementation of embodiments of the invention may take various forms and still be within the scope of the invention.

FIG. 3A shows examples of intervention point trigger conditions observed in historical job treatment data that could prompt a user to select an intervention point along with selected actions that the user would prefer under specific well treatment conditions. The user interface may capture the following characterizations of the intervention variable at a customer-selected point in time:
Rate of change in the variable for the preceding 40 seconds, 2 minutes, 5 minutes, and 10 minutes
The variable's difference from a customer-expected value
The variable's difference from a maximum allowable value

The quantifications of the variable at the customer-selected point in time may help define pattern recognition conditions to be utilized in Step 212 of FIG. 2A. The user's self-reported volumes, concentrations, rates, etc. for the selected actions, represented as the variables in quotes in FIG. 3A, may be recorded and utilized in Step 212 of FIG. 2A if an action is triggered.

FIG. 3B shows maximum and minimum allowable financial outcomes and operational outcomes of a utility model for a well completion operation. The outcomes may be assigned based on a conjoint analysis or similar technique. The utility functions may be utilized in an iterative optimization loop in Step 212 of FIG. 2A, constrained by user-defined minimums and maximums.

FIG. 3C shows a cost structure entry table that may be defined by subject matter experts for various services. The user may enter the unit of measure and/or unit cost for each service. FIG. 3C shows unit costs that could be captured for well completion operations. The total cost of ongoing operations may be calculated in Step 212 of FIG. 2A as part of the iterative optimization loop.

FIG. 3D shows risk tolerance values which may be used as a decision input in Step 212 of FIG. 2A. A series of questions regarding risk tolerance/acceptance may be translated into a single value ranging from 0 to 100. A value of 0 may correspond to a user who is willing to accept any proposed change in pursuit of optimization, and a value of 100 may correspond to a user who is unwilling to deviate from their plan. One use of the risk tolerance values may be as an input to authorize a suggested action based on cost modeling. For example, a user's risk tolerance combined with a probability of exceeding cost variance may be constrained to exceed a value of 100 in order for the recommendation engine to recommend an action. Another use of the risk tolerance values may be using a user's risk tolerance to pace the frequency of intervention during Step 212 of FIG. 2A. As demonstrated in FIG. 3D, a high risk tolerance corresponds to a reduced time between interventions. FIG. 3E shows that yet another use of the risk tolerance values is to determine acceptance of opportunities for optimization in Step 212 of FIG. 2A. If a pattern recognition score during real time operations of Step 212 is greater than an acceptance threshold, then an action may be recommended. The acceptance threshold is a function of the risk tolerance value.

FIG. 3F shows an example well setup and constraint table that a user may define for a specific well through an online application. The definition of the specific well may include assigning the appropriate models from Steps 202, 204, 206, and 208 of FIG. 2A if the user has multiple models available. In addition, the user may define physical constraints of the well and/or suppliers. The list of constraints may be specific to each type of service. An example of constraints for a well completion operation is provided below:
Well Definition=Unique Well Identifier (UWI) either randomly generated or the well's actual American Petroleum Institute (API) identification number.
Well Name & Number=a common description terminology.
Step 202: the user may have multiple intervention and action models based on different formations or geographies (e.g., eastern and western acreage positions, Eagle Ford and Bakken)
Step 204: the user may have multiple preference models based on economic or technical requirements of different formations or geographies
Step 206: the user may have multiple cost models for different vendors or the same vendor in different geographies
Step 208: the user may have different risk tolerance in different formations or geographies
the user may input the proposed service treatment plan (e.g., volumes, rates, pressure, concentrations, etc.) and the recommendation engine may calculate a cumulative cost curve at each second of the proposed treatment

FIG. 3G shows a table that indicates units of measure for different data channels consumed by a well completion operation. The on-location (e.g., at the well site) part of the system may accept a data feed from a service provider on location including variables similar to user input provided in Step 202 of FIG. 2A. For example, the data for a well completion operation may be supplied at a frequency of one data point per second.

FIG. 3H shows a real time optimization table that indicates expected physical responses and cost impacts for different potential actions in the context of simultaneous iterative optimization routines performed on the user's behalf. One use of the real time optimization table focuses on cost optimization. The recommendation engine tracks incurred costs based on applying real time data to a Cost Structure. The incurred cost is compared to a proposed cumulative cost generated during Step 210 of FIG. 2A. When the incurred cost model exceeds the proposed cumulative cost by a variance greater than what the user has defined in Step 204 of FIG. 2A, an action is triggered by the recommendation engine to keep costs within the acceptable cost window. The action results in the projected incurred cost aligning with the proposed cost at the end of the well treatment.

In FIG. 3H, the well treatment pressure is at 10,500 psi versus the planned pressure of 9,500 psi. The higher pressure results in an increased charge of $1,500 per hour from the service provider. The incurred cost model locks in the higher pumping charge just after halfway through the first hour of treatment. Because the user has a medium-low risk tolerance value of 38, as quantified in Step 208 of FIG. 2A, no action is triggered until the probability of exceeding the maximum cost variance from Step 204 of FIG. 2A is greater than 62%. In this example, excessive risk and cost probabilities occur between 50 and 60 minutes into the treatment. The recommendation engine then considers the actions available to reduce cost during the remaining 40-40 minutes of the well treatment that are in line with the user's preferred intervention actions from Step 202 of FIG. 2A.

Because the user has a low risk tolerance, the recommendation engine may select the option or combination of options that minimize the change from the planned execution using the relative values for variables defined in the utility functions from Step 202 of FIG. 2A. In this case, the set of changes that avoid cost variance while maximizing utility with the fewest number of changes reduces the rate slightly to avoid an incremental pressure charge and then reduces volume and sand slightly to offset the extra cost from the first hour of the well treatment, as shown in FIG. 3I. The result is the user's well treatment is 3% higher than the proposed cost with a slightly smaller volume and sand pumped, a combination that maximizes the user's utility function.

A parallel optimization routine focuses on pattern recognition in real time data to evaluate intervention options that deliver a user-preferred outcome. The pattern matching may attempt to find real time conditions that match a user's self-selected intervention points from Step 202 of FIG. 2A. The potential pattern matches may be scored on how closely they match each of the recorded user interventions on one or more of the following dimensions: rate of change, difference from user expectation, difference from absolute maximum, and relative time during treatment. The scores may be issued on a scale of 0 to 100, with 100 being an absolute match. The individual dimension match scores may be weighted to achieve a composite match score.

FIG. 3J shows an example of how the weighting might be performed. If the composite match score is greater than an acceptance threshold defined from a risk tolerance score of Step 208 of FIG. 2A, then the optimization opportunity is considered for action. A user-preferred action is selected based on user inputs from Step 202 of FIG. 2A. The consequence of the selected action is then evaluated through utility functions defined in Step 204 of FIG. 2A. This evaluation may include estimating the full treatment cost impact of the proposed action using the cost structure. If the proposed action increases the total utility value of the treatment, then the action is proposed for implementation on site.

The description of each proposed change is issued to the service company and user on-site representative in discrete user interface windows, each with an “Accept” and “Decline” button. If the “Accept” button is selected by the user then the change is logged and officially becomes part of the projected intervention cost. If the user selects “Decline” for a change that action is also logged, but financial impact is not incorporated into the projected intervention cost.

To prevent a continuous stream of changes based on real time data and optimization options that would be impractical and disruptive to operations on location, the recommendation engine may use an evaluation period after each accepted change. The evaluation period duration is explained as a function of customer's risk tolerance in Step 208 of FIG. 2A.

Embodiments of the invention may be implemented on a computing system. Any combination of mobile, desktop, server, router, switch, embedded device, or other types of hardware may be used. For example, as shown in FIG. 4A, the computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), and numerous other elements and functionalities.

The computer processor(s) (402) may be an integrated circuit for processing instructions. For example, the computer processor(s) may be one or more cores or micro-cores of a processor. The computing system (400) may also include one or more input devices (410), such as a touchscreen, keyboard, mouse, microphone, touchpad, electronic pen, or any other type of input device.

The communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

Further, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (400) in FIG. 4A may be connected to or be a part of a network. For example, as shown in FIG. 4B, the network (420) may include multiple nodes (e.g., node X (422), node Y (424)). Each node may correspond to a computing system, such as the computing system shown in FIG. 4A, or a group of nodes combined may correspond to the computing system shown in FIG. 4A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (400) may be located at a remote location and connected to the other elements over a network.

Although not shown in FIG. 4B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (422), node Y (424)) in the network (420) may be configured to provide services for a client device (426). For example, the nodes may be part of a cloud computing system. The nodes may include functionality to receive requests from the client device (426) and transmit responses to the client device (426). The client device (426) may be a computing system, such as the computing system shown in FIG. 2A. Further, the client device (426) may include and/or perform all or a portion of one or more embodiments of the invention.

The computing system or group of computing systems described in FIGS. 2A and 4B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 4A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The computing system in FIG. 4A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 4A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 4A and the nodes and/or client device in FIG. 4B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
monitoring a state of a service operation comprising settings and results to obtain a monitored state comprising at least trends in the results;
detecting, using the monitored state, an intervention point of a user;
identifying a change to the service operation corresponding to the intervention point; and
recommending the change to the service operation based on applying a utility model of the user to the monitored state.

2. The method of claim 1, further comprising:
obtaining historical data comprising intervention points and corresponding changes to the service operation; and
training, using the historical data, a learning model to learn a relationship between intervention points and changes to the service operation, wherein the change to the service operation is identified by the learning model.

3. The method of claim 1,
wherein the utility model comprises a risk tolerance preference of the user that indicates a criterion for matching the monitored state to the intervention point, and
wherein recommending the change to the service operation comprises determining that the change to the service operation satisfies, in the monitored state, the criterion.

4. The method of claim 1, further comprising:
determining that a trigger condition of the intervention point is satisfied by a result of executing the service operation in the monitored state.

5. The method of claim 1, wherein the utility model assigns a plurality of weights to a plurality of results generated during execution of the service operation.

6. A system comprising:
a computer processor;
a repository configured to store:
a service operation comprising a state comprising settings and results,
a plurality of intervention points each corresponding to a change to the service operation, and
a utility model of a user; and
a recommendation engine, executing on the computer processor and configured to:
monitor the state of the service operation to obtain a monitored state comprising at least trends in the results,
detect, for the user and using the monitored state, an intervention point of the plurality of intervention points;
identify a change to the service operation corresponding to the intervention point; and
recommend the change to the service operation based on applying the utility model of the user to the monitored state.

7. The system of claim 6, wherein the recommendation engine is further configured to:
obtain historical data comprising intervention points and corresponding changes to the service operation, and
train, using the historical data, a learning model to learn a relationship between intervention points and changes to the service operation, wherein the change to the service operation is identified by the learning model.

8. The system of claim 6,
wherein the utility model comprises a risk tolerance preference of the user that indicates a criterion for matching the monitored state to the intervention point, and
wherein recommending the change to the service operation comprises determining that the change to the service operation satisfies, in the monitored state, the criterion.

9. The system of claim 6, wherein the recommendation engine is further configured to:
determine that a trigger condition of the intervention point is satisfied by a result of executing the service operation in the monitored state.

10. The system of claim 6, wherein the utility model assigns a plurality of weights to a plurality of results generated during execution of the service operation.

11. A non-transitory computer readable medium comprising instructions that, when executed by a computer processor, perform:
monitoring a state of a service operation comprising settings and results to obtain a monitored state comprising at least trends in the results;
detecting, using the monitored state, an intervention point of a user;
identifying a change to the service operation corresponding to the intervention point; and
recommending the change to the service operation based on applying a utility model of the user to the monitored state.

12. The non-transitory computer readable medium of claim 11, wherein the instructions further perform:
obtaining historical data comprising intervention points and corresponding changes to the service operation; and
training, using the historical data, a learning model to learn a relationship between intervention points and changes to the service operation, wherein the change to the service operation is identified by the learning model.

13. The non-transitory computer readable medium of claim 11,
wherein the utility model comprises a risk tolerance preference of the user that indicates a criterion for matching the monitored state to the intervention point, and
wherein recommending the change to the service operation comprises determining that the change to the service operation satisfies, in the monitored state, the criterion.

14. The non-transitory computer readable medium of claim 11, wherein the instructions further perform:
determining that a trigger condition of the intervention point is satisfied by a result of executing the service operation in the monitored state.

15. The non-transitory computer readable medium of claim 11, wherein the utility model assigns a plurality of weights to a plurality of results generated during execution of the service operation.
